(19) United States
(12) Patent Application Publication
(10) Pub. No.: US 2016/0088225 A1
(43) Pub. Date: Mar. 24, 2016

(54) METHOD AND TECHNICAL EQUIPMENT FOR IMAGING

(71) Applicant: Nokia Technologies Oy, Espoo (FI)

(72) Inventors: Euan Barron, Tampere (FI); Juuso Gren, Kyrokoski (FI); Mikko Muukki, Tampere (FI); Tomi Sokeila, Tampere (FI)

(73) Assignee: Nokia Technologies Oy, Espoo (FI)

(21) Appl. No.: 14/782,643

(22) PCT Filed: Apr. 11, 2013
(86) PCT No.: PCT/FI2013/050396

§ 371 Date: Oct. 6, 2015

(51) Int. Cl. H04N 5/232; H04N 5/235

(52) U.S. Cl. CPC H04N 5/23251; H04N 5/2353

(57) ABSTRACT

The application concerns a method and a technical equipment for multiframe capturing. In the method a level of motion in a target to be captured is determined (402); capture parameters to be used in multiple frame capture of the target are adapted according to the determined level of motion (405); and the multiple frame capture is performed with the capture parameters (410). The application also concerns an apparatus and computer program.

### TECHNICAL FIELD

The present application relates generally to imaging. In particular the present application relates to multiframe imaging.

### BACKGROUND

In the field of computational photography, many algorithms are using multiple captured frames, which are combined into one frame. This will enhance the digital photography, because multiple pictures (i.e. frames) of the same object, having different capturing settings can be used to extend the characteristics of the picture, when such multiple pictures are combined. However, imaging devices having a single camera suffer from time difference or used exposure time between the captured frames.

There is, therefore, a need for a solution that minimizes the problems relating to such differences.

### SUMMARY

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, there is provided a method comprising determining a level of motion in a target to be captured; adapting capture parameters to be used in multiple frame capture of the target according to the determined level of motion; and performing the multiple frame capture with the capture parameters.

According to a second aspect, an apparatus comprises at least one processor, at least one memory including computer program code, the at least one memory and the computer program code configured to, with the at least one processor, cause the apparatus to perform at least the following: determining a level of motion in a target to be captured; adapting capture parameters to be used in multiple frame capture of the target according to the determined level of motion and performing the multiple frame capture with the capture parameters.

According to a third aspect, an apparatus, comprises at least: means for determining a level of motion in a target to be captured; means for adapting capture parameters to be used in multiple frame capture of the target according to the determined level of motion; and means for performing the multiple frame capture with the capture parameters.

According to a fourth aspect, a computer program, comprises code for determining a level of motion in a target to be captured; and code for adapting capture parameters to be used in multiple frame capture of the target according to the determined level of motion, and code for performing the multiple frame capture with the capture parameters, when the computer program is run on a processor.

According to a fifth aspect, a computer-readable medium is encoded with instructions that, when executed by a computer, perform: determining a level of motion in a target to be captured; adapting capture parameters to be used in multiple frame capture of the target according to the determined level of motion and performing the multiple frame capture with the capture parameters.

According to an embodiment, for high motion, short exposure times are set for the multiple frames.

According to an embodiment, for small motion, long exposure times are set for the multiple frames.

According to an embodiment, the number of frames to be captured are determined according to the determined level of motion, wherein for high motion, less frames are captured than for small motion.

According to an embodiment, two exposures are performed simultaneously during a capture.

According to an embodiment, one of the exposures is main exposure, and another of the exposures is relative to the main exposure.

According to an embodiment, it is automatically identified whether an exposure is a main exposure or a relative exposure.

According to an embodiment, the main exposure and the relative exposure is set in such a manner that the determined level of motion defines the difference between the main exposure and the relative exposure.

According to an embodiment, the apparatus comprises a computing device comprising: a user interface circuitry and user interface software configured to facilitate a user to control at least one function of the apparatus through use of a display and further configured to respond to user inputs; and a display circuitry configured to display at least a portion of a user interface of the apparatus, the display and display circuitry configured to facilitate the user to control at least on function of the apparatus.

According to an embodiment, the computing device comprises a mobile phone.

### BRIEF DESCRIPTION OF THE DRAWINGS

In the following, various embodiments of the invention will be described in more detail with reference to the appended drawings, in which

FIG. 1 shows an apparatus according to an embodiment;

FIG. 2 shows a layout of an apparatus according to an embodiment;

FIG. 3 shows a system according to an embodiment;

FIG. 4 shows an embodiment of a method.

### DESCRIPTION OF EXAMPLE EMBODIMENTS

Autoexposure (AE) algorithm is known to be used to set exposure parameters for normal (i.e. not under process of computational photography) image before image is captured. If a computational algorithm requires different parameters (e.g. over exposure or under exposure), those are usually set with fixed offsets from AE reference. Typical use case is high dynamic range (HDR) imaging. In some cases the offset from the AE reference is set adaptively by analyzing the statistics of the image. However, the analysis is based on analyzing the exposure, i.e. intensity, and ignoring other important factors, like motion blur. If such factors were taken into account in fixed (not adaptive) way, it would limit the power of the algorithms.

The present embodiments enable decreasing the amount of artifacts in multiframe imaging, e.g. HDR. Or in other words, enable increasing the quality of the algorithm by letting the algorithm to use better parameters than would be safe by default.

The artifacts are caused to HDR and other multiframe algorithms by differences between the user input frames. Differences can be caused by time difference between the frames or different exposure times in the frames. Especially motion blur (global or local) may cause problems and artifacts to the processed output images.

There are various way to detect, if and how much there is movement in the scene. Hardware sensors (e.g. gyroscope, accelerometer) and software analysis (motion vectors, contrast and gradient based calculations, etc.) can be mentioned as examples.

Instead of fixing the camera parameters for each capture based on exposure analysis only, the present embodiments propose including motion information to the decision making. Motion information relates to the amount of motion in the scene, i.e. “small motion” or “high motion” (in some cases also “medium motion”). The borderline between small and high motion is based on used algorithms, i.e. how much motion blur an algorithm can handle. For example, some algorithms can handle some amount of motion blur, but some other algorithms cannot handle any motion blur. Also the quantity of the motion can be very different. Therefore, for the purposes of the present solution, it does not matter how small and high motion is defined, because the determination may be done for each use case depending on e.g. user preferences, multiframe algorithm behavior, etc. Therefore, what matters in these embodiments, is that the determination between small and high motion has been done and that information is further utilized for optimizing capture parameters.

For scenes with small movement, longer exposure times can be set, or more images can be taken to be used as input for the algorithm. This will reduce noise in the image and increase the dynamic range for HDR. For scenes with high movement, the parameters can be optimized for quick capture (e.g. high framerate, short exposure times, higher gains, less images). By each of these parameters, the visual quality of the output image is optimized. The present embodiments relate to pre-processing of images, which means that the processing algorithm takes place before capturing images. Therefore, problems occurring in known solutions can be avoided beforehand.

The present embodiment can be used for generic optimization purposes. In particular, the present embodiment can be used with HDR. The present embodiment is applicable for traditional HDR imaging with multiple captures (e.g. three captured frames with different exposures).

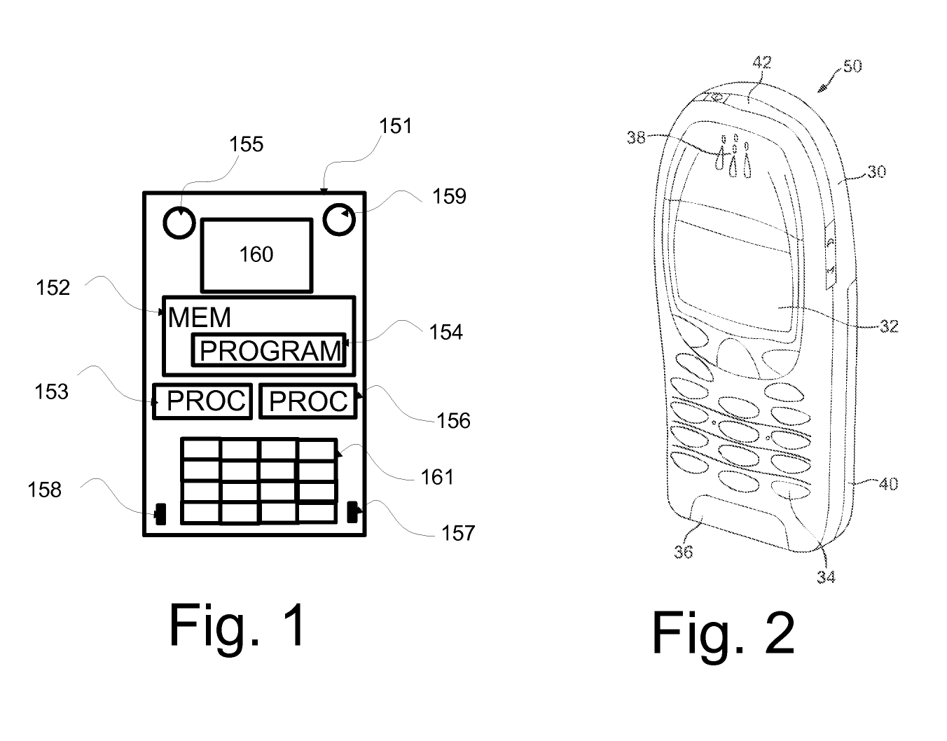

FIG. 1 illustrates an apparatus 151 according to an embodiment. The apparatus 151 contains memory 152, at least one processor 153 and 156, and computer program code 154 residing in the memory 152. The apparatus according to the example of FIG. 1, also has one or more cameras 155 and 159 for capturing image data, for example stereo video. However, for the purposes of the present embodiment, only one camera may be utilized. The apparatus may also contain one, two or more microphones 157 and 158 for capturing sound. The apparatus may also contain sensor for generating sensor data relating to the apparatus' relationship to the surroundings. The apparatus also comprises one or more displays 160 for viewing single-view, stereoscopic (2-view) or multiview (more-than-2-view) and/or previewing images. Anyone of the displays 160 may be extended at least partly on the back cover of the apparatus. The apparatus 151 also comprises an interface means (e.g. a user interface) which allows a user to interact with the apparatus. The user interface means is implemented either using one or more of the following: the display 160, a keypad 161, voice control, or other structures. The apparatus is configured to connect to another device e.g. by means of a communication block (not shown in FIG. 1) able to receive and/or transmit information.

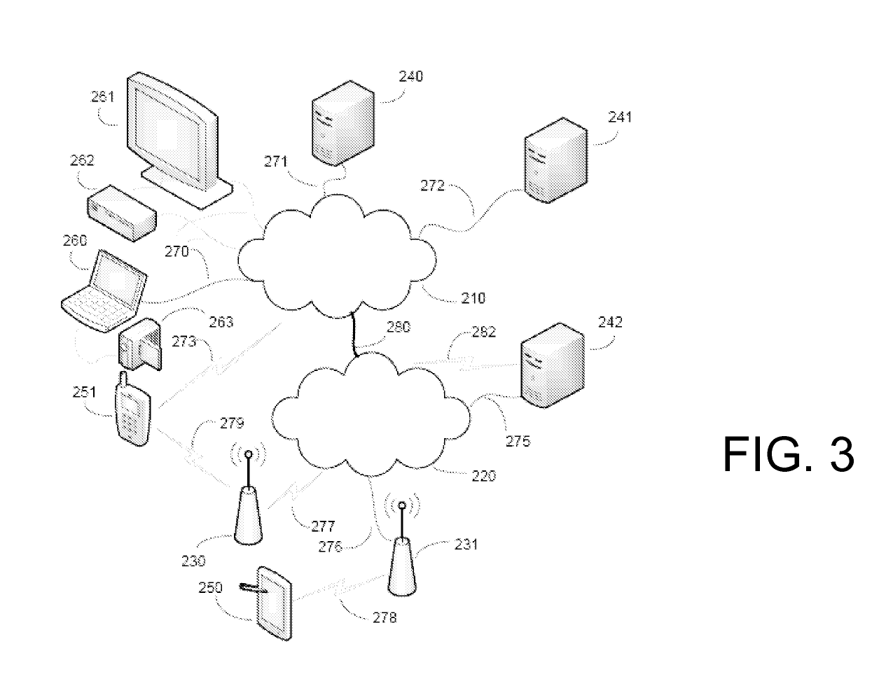

FIG. 2 shows a layout of an apparatus according to an example embodiment. The apparatus 50 is for example a mobile terminal (e.g. mobile phone, a smart phone, a camera device, a tablet device) or other user equipment of a wireless communication system. Embodiments of the invention may be implemented within any electronic device or apparatus, such a personal computer and a laptop computer.

The apparatus 50 shown in FIG. 2 comprises a housing 30 for incorporating and protecting the apparatus. The apparatus 50 further comprises a display 32 in the form of e.g. a liquid crystal display. In other embodiments of the invention the display is any suitable display technology suitable to display an image or video. The apparatus 50 may further comprise a keypad 34 or other data input means. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 of FIG. 2 also comprises a battery 40 (or in other embodiments of the invention the device may be powered by any suitable mobile energy device such as solar cell, fuel cell or clockwork generator). The apparatus according to an embodiment may comprise an infrared port 42 for short range line of sight communication to other devices. In other embodiments the apparatus 50 may further comprise any suitable short range communication solution such as for example a Bluetooth wireless connection, Near Field Communication (NFC) connection or a USB/firewire wired connection.

FIG. 3 shows an example of a system, where the apparatus is able to function. In FIG. 3, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 3 are shown servers 240, 241 and 242, each connected to the mobile network 220, which servers, or one of the servers, may be arranged to operate as computing nodes (i.e. to form a cluster of computing nodes or a so-called server farm) for a social networking service. Some of the above devices, for example the computers 240, 241, 242 may be such that they are arranged to make up a connection to the Internet with the communication elements residing in the fixed network 210.

There are also a number of end-user devices such as mobile phones and smart phones 251 for the purposes of the present embodiments, Internet access devices (Internet tablets) 250, personal computers 260 of various sizes and formats, and computing devices 261, 262 of various sizes and formats. These devices 250, 251, 260, 261, 262 and 263 can also be made of multiple parts. In this example, the various devices are connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection. All or some of these devices 250, 251, 260, 261, 262 and 263 are configured to access a server 240, 241, 242 and a social network service.

A method according to an embodiment is described by means of following example:

Autoexposure proposes 30 ms exposure time and 1×gain. HDR algorithm needs two additional frames, e.g. +/−1 exposure value (EV) shifts. Known methods would use parameters such as 15 ms with 1×gain and 60 ms with 1×gain (or similar).

By the present embodiments, the used capture parameters are adaptive to motion. For scenes with small movement, longer exposure times can be set, or more images can be taken to be used as input for the algorithm. For scenes with high movement, the parameters can be optimized for quick capture (e.g. high framerate, short exposure times, higher gains, less images).

For example:
with high motion:
   low exposure frame (7.5 ms, 2×gain),
   normal exposure frame (15 ms, 2×gain),
   high exposure frame (15 ms, 4×gain)
with low motion:
   extra low exposure frame (7.5 ms, 1×gain),
   low exposure frame (15 ms, 1×gain),
   normal exposure frame (30 ms, 1×gain),
   high exposure frame (60 ms, 1×gain),
   extra high exposure frame (60 ms, 2×gain).

As another use case, HDR with different exposures during the single capture (e.g. half of the lines are exposed longer than the rest of lines in sensor). Such a use case is common in HDR video recording. The ratio of the exposure times between the differently exposure lines will cause tradeoff between motion artifacts and improvement in dynamic range. The higher the difference is, the better dynamic range will be achieved. However, more artifacts will occur. Traditionally the ratio is fixed during the recording. According to an embodiment, the difference is made adaptive according to the detected motion (global and/or local). The benefits of that is that it optimizes the visual quality.

The process according to an embodiment may contain the following:
at first a decision to take multiple images, e.g. HDR image, is made;
then the capture/camera parameters are optimized for multiframe algorithm(s). For example, the maximum exposure time is set and based on the algorithm requirements, the optimal exposure parameters are applied.

In the present embodiments, two exposures can be captured simultaneously in the sensors. One is a main exposure and another is a relative exposure. The relative exposure can be shorter or longer than the main exposure, but is relative to the main exposure (i.e. main multiplied by some factor). In the present embodiments, it is possible to identify whether the exposure is a main exposure or a relative exposure. The information on the used exposure can be located in a frame metadata. However, with adaptive algorithms, the information on the user exposure may not be necessary. The higher the difference between the main exposure and the relative exposure is, the better dynamic range is obtained. In other words, when there is high motion, a small difference is desired and penalty in dynamic range is accepted. With low motion, the difference is increased.

In above, embodiments for optimizing camera parameters at the beginning (i.e. pre-processing) to avoid or to reduce any difference problems. This means that with present embodiments, the input images to be used will be as sharp as needed since for some algorithms small motion blur is allowed while most multiframe algorithms will need as sharp images as possible for the best result. Invention optimizes captured images (before the capture) in order to avoid many problems.

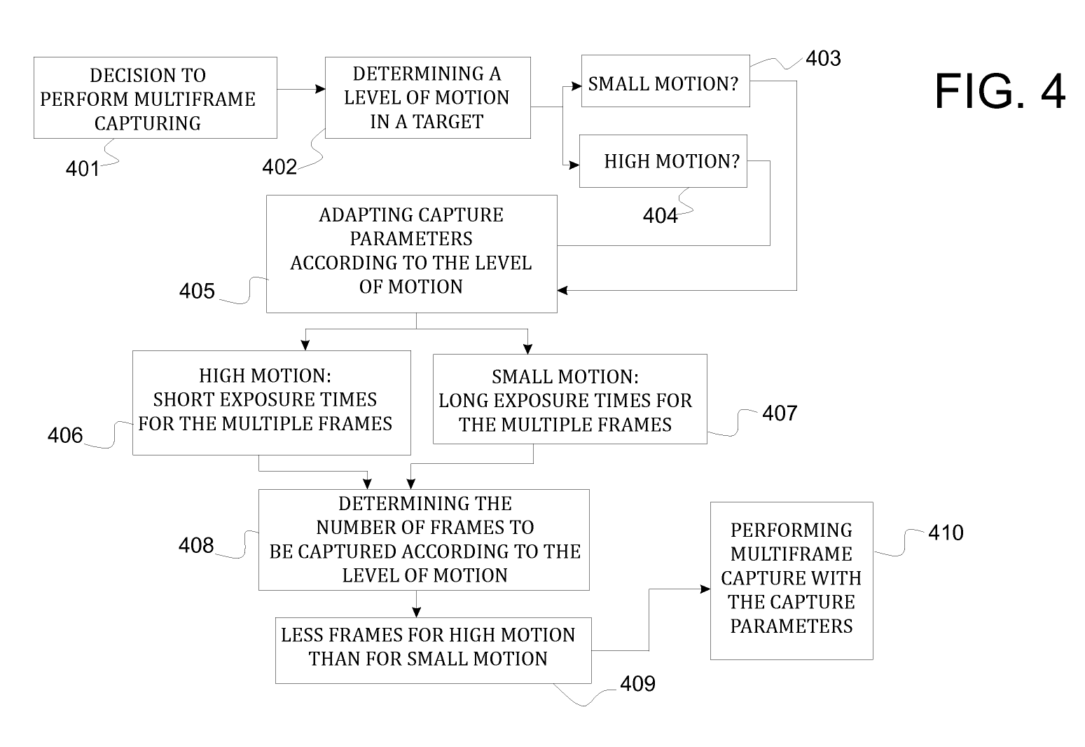

An embodiment of a method is illustrated in FIG. 4. At first 401, a decision to perform multiframe capturing is made. Then 402, a level of motion in a target scene is determined. The level of motion can be small motion 403 or high motion 404. The capturing parameters are then adapted 405 according to the level of motion. For high motion 406, short exposure times are used for the multiple frames. For small motion 407, long exposure times are used for the multiple frames. Then the number for frames is determined according to the level of motion 408. In multiframe capturing, less frames are captured for high motion than for small motion 409. In some cases, the motion may be too high, whereby the output (e.g. from block 408) may be, that only one frame is captured or at least used in final processing. This means that the multiframe is changed to single frame on the fly. After the capturing parameters have been determined, the multiframe capturing can be performed with the determined capture parameters 410.

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1-28. (canceled)

29. A method, comprising:
determining a level of motion in a target to be captured;
adapting capture parameters to be used in multiple frame capture of the target according to the determined level of motion; and
performing the multiple frame capture with the capture parameters.

30. The method according to claim 29, wherein the level of motion is high, the method further comprises:
setting short exposure times for the multiple frames.

31. The method according to claim 29, wherein the level of motion is small, the method further comprises:
setting long exposure times for the multiple frames.

32. The method according to claim 29, further comprising:
determining the number of frames to be captured according to the determined level of motion, wherein for high motion, less frames are captured than for small motion.

33. The method according to claim 29, further comprising:
performing two exposures simultaneously during a capture.

34. The method according to claim 33, wherein one of the exposures is main exposure, and another of the exposures is relative to the main exposure.

35. The method according to claim 34, further comprising automatically identifying whether an exposure one of a main exposure and a relative exposure.

36. The method according to claim 34, further comprising:
setting the main exposure and the relative exposure in such a manner that the determined level of motion defines the difference between the main exposure and the relative exposure.

37. An apparatus comprising:
at least one processor,
at least one memory including computer program code,
the at least one memory and the computer program code configured to, with the at least one processor, cause the apparatus to perform at least the following:
determine a level of motion in a target to be captured;
adapt capture parameters to be used in multiple frame capture of the target according to the determined level of motion; and
perform the multiple frame capture with the capture parameters.

38. The apparatus according to claim 37, wherein the level of motion is high, the at least one memory and the computer program code configured to, with the at least one processor, cause the apparatus further to perform:
set short exposure times for the multiple frames.

39. The apparatus according to claim 37, wherein the level of motion is small, the at least one memory and the computer program code configured to, with the at least one processor, cause the apparatus further to perform:
set long exposure times for the multiple frames.

40. The apparatus according to claim 37, wherein the at least one memory and the computer program code configured to, with the at least one processor, cause the apparatus further to perform:
determine the number of frames to be captured according to the determined level of motion, wherein for high motion, less frames are captured than for small motion.

41. The apparatus according to claim 37, wherein the at least one memory and the computer program code configured to, with the at least one processor, cause the apparatus further to perform:
perform two exposures simultaneously during a capture.

42. The apparatus according to claim 41, wherein one of the exposures is main exposure, and another of the exposures is relative to the main exposure.

43. The apparatus according to claim 42, wherein the at least one memory and the computer program code configured to, with the at least one processor, cause the apparatus further to perform:
automatically identifying whether an exposure one of a main exposure and a relative exposure.

44. The apparatus according to claim 42, wherein the at least one memory and the computer program code configured to, with the at least one processor, cause the apparatus further to perform:
set the main exposure and the relative exposure in such a manner that the determined level of motion defines the difference between the main exposure and the relative exposure.

45. A computer-readable medium encoded with instructions that, when executed by a computer, perform:
determining a level of motion in a target to be captured;
adapting capture parameters to be used in multiple frame capture of the target according to the determined level of motion and
performing the multiple frame capture with the capture parameters.

46. The computer-readable medium according to claim 45, wherein the level of motion is high, the method further comprises:
setting short exposure times for the multiple frames.

47. The computer-readable medium according to claim 45, wherein the level of motion is small, the method further comprises:
setting long exposure times for the multiple frames.

48. The computer-readable medium according to claim 45, further comprising:
determining the number of frames to be captured according to the determined level of motion, wherein for high motion, less frames are captured than for small motion.

49. The computer-readable medium according to claim 45, further comprising:
performing two exposures simultaneously during a capture.
